(19) United States
(12) Patent Application Publication
(10) Pub. No.: US 2005/0103766 A1
(43) Pub. Date: May 19, 2005

(54) Automatic groove copy welder and welding method

(76) Inventors: Takahisa Iizuka, Noda-Shi, Chiba-Ken (JP); Hideaki Mizuno, Noda-Shi, Chiba-Ken (JP); Hiroki Kinoshita, Noda-Shi, Chiba-Ken (JP)

Correspondence Address: OLIFF & BERRIDGE, PLC, P.O. BOX 19928, ALEXANDRIA, VA, 22320, US

(21) Appl. No.: 10/504,907

(22) PCT Filed: Mar. 4, 2003
(86) PCT No.: PCT/JP03/02472

(30) Foreign Application Priority Data
Mar. 4, 2002 (JP) 2002-057418
Apr. 18, 2002 (JP) 2002-115691

(51) Int. Cl. B23K 9/12

(52) U.S. Cl. 219/124.34

(57) ABSTRACT

An automatic groove-tracing welding system is capable of carrying out a welding operation, particularly, a welding operation involving weaving, without requiring monitoring even if conditions of a groove is different from design conditions of the groove. An image processor 3 receives an image signal representing an image of a weld zone 52 including the tip of a welding wire from a camera head 2 provided with a CCD camera, processes the image of the weld zone 52 to determine the position of a groove, calculates the positional relation of the groove with a welding torch 1, and sends a position correction for correcting the position of the welding torch 1 so that the welding path of the tip of the welding torch 1 may coincide with a predetermined middle part in the groove to a robot controller 43 for controlling a welding robot. When the automatic groove-tracing welding system performs a welding operation involving weaving, the image processor 3 receives a weaving phase signal representing phases of weaving from the robot controller 43, calculates the positional relation between the groove and the welding torch on the basis of the phase of weaving, and sends a weaving width correction signal to the robot controller 43.

### TECHNICAL FIELD

The present invention relates to an automatic groove-tracing welding method of welding workpieces along an actual groove on the basis of an image of a weld zone including the tip of the welding wire, and an automatic groove-tracing welding system for carrying out the same. The present invention relates also to an automatic welding machine capable of accurately carrying out groove-tracing welding involving weaving.

### BACKGROUND ART

An automatic welding machine using a general-purpose robot or a welding robot is used for mass-producing standardized articles by welding and, in some cases, a weld monitor is used in combination with the automatic welding machine. The weld monitor takes the tip of a welding torch, and a weld zone including a molten pool with a camera head attached to the welding torch, and displays an image of the tip of the welding torch and the weld zone on the screen of a TV monitor.

A technique disclosed in JP-A 11-146387 takes a weld zone with a plurality of cameras respectively provided with filters respectively having different transmittances, and composes an image from an image of a highly luminous electric arc, and an image of the weld zone excluding the electric arc. This known technique enables the real-time observation of the weld zone. However, only a skilled welding operator is able to recognize the condition of a molten pool accurately from the displayed image. Moreover, it is not easy for the welding operator to judge the condition of the weld zone from the displayed image of the weld zone and to operate the welding machine so that the workpieces may be welded along a weld line under proper welding conditions.

A monitor disclosed in JP-A 2001-000038 decomposes a color image signal representing a color image of a weld zone taken by a color camera into an R-, a G- and a B-component signals by an image processor, estimates the range of a molten pool on the basis of the intensities of the component signals or the ratio between the component signals, determines the position of the weld line on the basis of the color image signal, produces welding conditions and welding correction information necessary for welding work including weld line tracing on the basis of the shape of the molten pool and the positional relation of the molten pool with the weld line, making reference to a welding database, and displays the welding conditions and the welding correction information on the screen of a display.

This monitor provides auxiliary information to prevent the welding operator from misreading the condition of the molten pool and the position of the weld line. However, the welding machine is operated after a skilled welding operator has made a judgment from the image, and the reliability of the information provided by the monitor is not high enough to operate an automatic welding machine in a feedback control mode using the information provided by the monitor.

In welding using a nonconsumable electrode, such as TIG welding, the welding condition of workpiece is disturbed by a slight cause and parts, on the opposite sides of a weld line, of the workpiece are melted in different molten states, respectively. Thus, the welding operator needs to adjust the position of the welding wire manually to ensure a satisfactory weld quality. However, it has been difficult to carry out the adjustment of the position of the welding wire automatically.

### DISCLOSURE OF THE INVENTION

Accordingly, it is an object of the present invention to provide an automatic groove-tracing welding system capable of carrying out a desired welding operation without requiring monitoring even if the condition of a groove does not conform to design conditions. Another object of the present invention is to provide an automatic welding machine capable of accurately carrying out groove-tracing welding involving weaving. A third object of the present invention is to provide an automatic groove-tracing welding system having a high added value by combining a conventional weld zone monitor additional provided with an automating function and an automatic welding robot.

A fourth object of the present invention is to provide an automatic groove-tracing welding system capable of preventing parts, on the opposite sides of a weld line, of workpiece from being melted differently during TIG welding or the like.

According to one aspect of the present invention, an automatic groove-tracing welding system comprises: a welding torch guide device; an imaging device; and an image processor; wherein the imaging device produces an image signal representing an image of a weld zone including the tip of a welding wire, the image processor receives the image signal from the imaging device, and a torch tip position information about the position of the tip of the welding torch from the welding torch guide device, determines the position of a groove from the image of the weld zone, calculates the positional relation between the groove and the welding torch on the basis of the torch tip position information, and sends a position correction signal for correcting the position of the tip of the welding torch so that the welding path of the tip of the welding torch may coincide with a weld line coinciding with a predetermined middle part of the groove to the welding torch guide device.

The present invention is applicable to both consumable-electrode arc welding machines using a consumable electrode and nonconsumable-electrode arc welding machines using a nonconsumable electrode. Since nonconsumable-electrode arc welding using a nonconsumable electrode needs an electrode feed device for feeding and guiding a welding wire or a welding rod in addition to a welding torch. Therefore, a nonconsumable-electrode arc welding machine is provided with a welding wire feed device to feed a welding wire or the like so that the welding wire follows an electric arc and to control the position of the welding wire intentionally.

The automatic groove-tracing welding system of the present invention estimates the position of the groove through the detection of a feature point from the degrees of brightness of parts of the image or from the RGB ratio, decides the position of the tip of the welding wire in the image by utilizing position information provided by the welding torch guide device, such as a general-purpose robot or a welding robot, and gives a correction signal to the welding torch guide device when the position of the welding torch does not coincide with the center line of the groove to correct a control operation during a welding process to guide the welding torch so that the position of the welding torch may be on the centerline of the groove.

The automatic groove-tracing welding system of the present invention may be capable of a weaving operation. Preferably, the image processor receives a weaving phase signal representing a weaving phase from the welding torch guide device, calculates the positional relation between the groove and the welding torch on the basis of the weaving phase, and sends a weaving width correction signal for correcting weaving width to the welding torch guide device.

Positions for measuring the relation between the groove and the welding torch and those for correcting the weaving width according to the weaving width correction signal may be alternately arranged to withhold the correction of the position of the welding torch during the measurement of the relation between the groove and the welding torch.

Preferably, the positional relation between the groove and the welding torch is determined and a weaving width correction signal is sent to the welding torch guide device in the first half of a weaving period, and the position of the welding torch is corrected in the second half of the weaving period.

Preferably, a correction to be made in one weaving period may be divided into n fractional corrections and the weaving width is corrected little by little at 1/n of the weaving period to form a smooth weld face. The value of n is an integer and one of those that facilitate the arithmetic operation of an electronic computer, such as 8 and 16.

The period for the calculation of the weaving width correction is not limited to half the weaving period and the calculation of the weaving width correction may be performed every m (m is an integer) weaving periods.

The sectional shape of the groove may be calculated and the range of weaving can be corrected so as to conform to the sectional shape of the groove. When multilayer welding is required, the position of the tip of the welding wire is adjusted so as to change from a position corresponding to the bottom weld layer to a position corresponding to the top weld layer. Since the surfaces defining the groove are inclined, it is preferable to use a greater weaving width for an upper weld layer to melt the surfaces of the groove and to change the amount of the weld metal. For that purpose, it is preferable that the automatic groove-tracing welding system of the present invention measures the position and shape of the groove and uses the measured position and shape of the groove for weaving control.

The position of the groove can be determined from an image produced by an imaging device, and the sectional shape can be obtained from the welding torch guide to which information about the shape of the groove is taught. Section information about the sectional shape of the groove may be entered or may be obtained by processing the image.

Preferably, the image processor determines the longitudinal direction of the groove by processing the image and traversing directions for weaving may be corrected so as to be perpendicular to the longitudinal direction of the groove. If the position of a workpiece is different from a design position, weld beads extend obliquely to the groove even if the welding torch is moved along the groove when the set directions of weaving is not changed and, consequently, satisfactory welding cannot be achieved. Weld beads having a beautiful weld face can be formed by using the weaving direction correcting method of the present invention.

A filler metal can be deposited in a uniform thickness and a high weld quality by decreasing welding speed when the groove has a big width or increasing welding speed when the groove has a small width.

The imaging device must be located so as to overview the weld zone including the tip of a welding wire. When the imaging device is fixed relative to the welding torch by, for example, attaching the imaging device to a support arm fixed to the welding torch, the tip of the welding wire is always at a fixed position in the image taken by the imaging device, which simplifies and facilitates the image processing operation of the image processor.

Thus, the automatic groove-tracing welding system of the present invention operates automatically without requiring monitoring.

The image processor included in the automatic groove-tracing welding system of the present invention may be an electronic computer, such as a personal computer. An electronic computer is capable of easily carrying out appurtenant operations including those for storing and displaying processed images and logging a welding path in addition to the generation of the correction signals. The automatic groove-tracing welding system may be additionally provided with a conventional welding monitor.

In some cases, the welding wire is melted differently for the opposite surfaces of a groove and welding quality is deteriorated when the welding torch is not moved for weaving and is moved linearly along the groove. In such a case, the operator monitors the condition of a molten pool, and shifts the tip of the welding wire toward one part of the molten pool on one side of the tip of the welding wire having a front end lying behind the front end of the other part of the molten pool when the welding is unbalanced to balance the respective conditions of the right and the left part of the molten pool. Since the automatic groove-tracing welding system includes the imaging device for obtaining an image of a weld zone and an image processor, the automatic groove-tracing welding system is able to achieve automatic compensation control by detecting the condition of a front part of a molten pool by the agency of the imaging device and the image processor, and adjusting the position of the tip of the welding wire by using a signal representing information about the condition of the front part of the molten pool, when the automatic groove-tracing welding system is used for nonconsumable electrode welding.

An automatic groove-tracing welding method using a remote-controlled welding torch guide device comprises: generating an image signal by taking an image of a weld zone including the tip of a welding wire; detecting the position of a groove from the image signal representing the image of the weld zone; obtaining welding torch tip position information about the position of the tip of a welding torch from the welding torch guide device; calculating the positional relation between the groove and the tip of the welding wire on the basis of the welding torch tip position information; and achieving welding position control by sending a position correction signal to the welding torch guide device to adjust the welding path of the tip of the welding torch so that the welding path of tip of the welding torch may coincide with a predetermined middle position in the groove.

The automatic groove-tracing welding method of the present invention estimates the position of the groove through the detection of a feature point from the degrees of brightness of parts of the image or the RGB ratio, decides the position of the tip of the welding wire in the image from position information provided by the welding torch guide device, such as a general-purpose robot or a welding robot, and gives a correction signal to the welding torch guide device when the position of the welding torch is not on the centerline of the groove to correct a control operation during a welding process to guide the welding torch so that the position of the welding torch may be on the centerline of the groove. Thus, high-quality welding can be automatically achieved.

### BRIEF DESCRIPTION OF THE DRAWINGS

FIG. 1 is a block diagram of an automatic groove-tracing welding system in a first embodiment according to the present invention;

FIG. 2 is a conceptional view of an image used by the automatic groove-tracing welding system in the first embodiment;

FIG. 3 is a diagrammatic view of assistance in explaining an image processing method to be carried out by the automatic groove-tracing welding system in the first embodiment;

FIG. 4 is a diagrammatic view of assistance in explaining another image processing method to be carried out by the automatic groove-tracing welding system in the first embodiment;

FIG. 5 is a diagrammatic view of assistance in explaining a weaving correction calculating procedure to be carried out by the automatic groove-tracing welding system in the first embodiment;

FIG. 6 is a flow chart of assistance in explaining the operation of the automatic groove-tracing welding system in the first embodiment;

FIG. 7 is a diagram of assistance in explaining the timing for measuring, evaluation and correction of the automatic groove-tracing welding system in the first embodiment for measurement;

FIG. 8 is a graph showing the change of cumulative correction in a welding control test using the automatic groove-tracing welding system in the first embodiment;

FIG. 9 is a graph of assistance in explaining a method of estimating a weaving width error to be carried out in a welding control test using the automatic groove-tracing welding system in the first embodiment;

FIG. 10 is a graph showing the result of weaving width direction control in a welding control test using the automatic groove-tracing welding system in the first embodiment;

FIG. 11 is a graph showing the welding path of the tip of a welding wire in a welding control test using the automatic groove-tracing welding system in the first embodiment;

FIG. 12 is a block diagram of an automatic groove-tracing welding system in a second embodiment according to the present invention;

FIG. 13 is a conceptional view of an image obtained by the automatic groove-tracing welding system in the second embodiment; and

FIG. 14 is a diagrammatic view of assistance in explaining steps of a control procedure to be carried out by the automatic groove-tracing welding system in the second embodiment.

### BEST MODE FOR CARRYING OUT THE INVENTION

Preferred embodiments of the present invention will be described with reference to the accompanying drawings.

First Embodiment

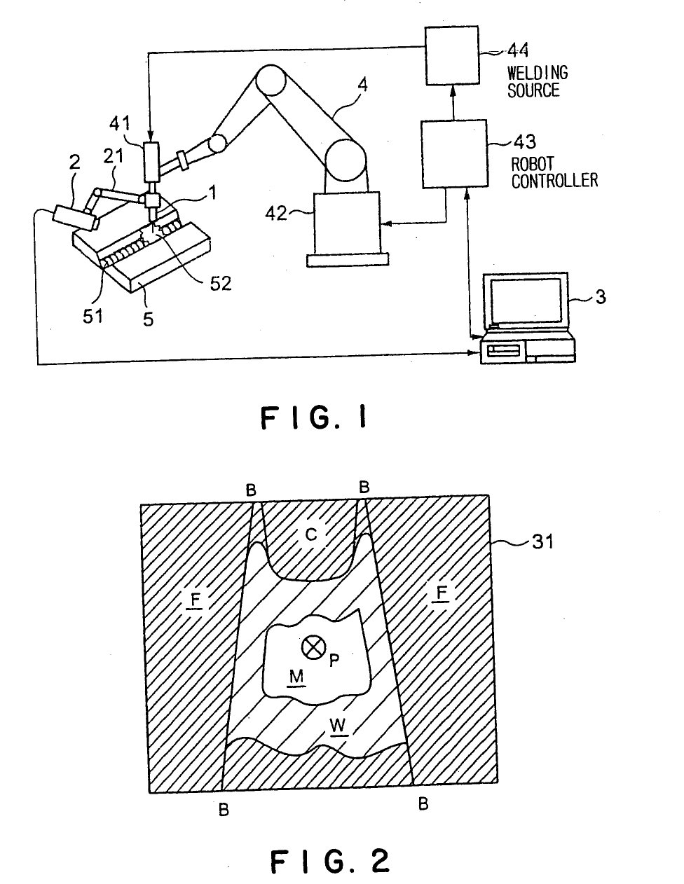

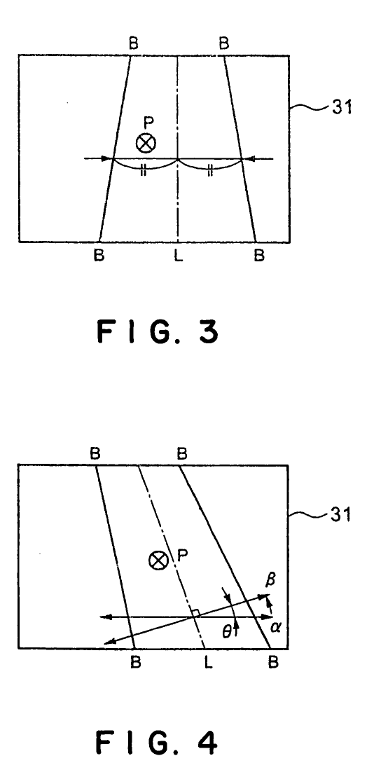

FIG. 1 is a block diagram of an automatic groove-tracing welding system in a first embodiment according to the present invention.

The automatic groove-tracing welding system in the first embodiment includes a welding torch 1, a camera head 2 combined with the welding torch 1, an image processor 3, and a welding robot 4. The welding robot 4 has an articulated robot arm 42 provided at its extremity with a robot hand holding a welding machine 41 provided with the welding torch 1, a robot controller 43, and a welding source 44 for supplying welding electric power to the welding machine 41.

The welding torch 1 is controlled according to a control program set beforehand for the welding robot 4 so as to move along a groove 51 formed in a workpiece 5 and to melt a welding wire to deposit a weld metal in the groove 51.

The camera head 2 provided with a CCD camera is attached to the free end of a support arm 21 fixed to the welding torch 1 such that a weld zone 52 at the tip of the welding wire is included in the visual field of the CCD camera. Preferably, the camera head 2 is supported with the optical axis of the CCD camera directed in the moving direction of the welding torch 1. The camera head 2 may be provided with a color CCD camera capable of producing a color image.

The image processor 3 receives an image signal from the camera head 2 and displays an image on a display, processes the image signal to obtain necessary information, calculates a position correction for correcting the position of the welding torch 1 and gives the position correction to the robot controller 43. The image processor 3 may be a personal computer including a display.

As shown in FIG. 2, a weld zone image 31 produced by the CCD camera of the camera head 2 during welding has a very bright region M, a bright region W surrounding the very bright region, and a dark region F around the bright region.

The very bright region M is an image of a highly luminous electric arc discharged from the tip P of a welding wire at a substantially central position in the image determined by the positional relation between the camera head 2 and the welding torch 1, and of a melting zone around the electric arc. The bright region W is an image of a weld surface and the inclined walls of the groove 51 illuminated by the electric arc. The dark region F is an image of part of the workpiece 5 not illuminated by the electric arc. A dark region C is an image of the surface of the welding torch 1.

Boundaries between the dark regions F and the bright region W correspond to the edges B of the groove 51. The edges B of the groove 51 can be determined through feature extraction from the image signal using brightness change.

In case of a straight welding, for example, the welding torch 1 is guided so that the tip P of the welding wire moves along the centerline of the groove 51, namely, a middle line bisecting a space between the opposite edges B of the groove 51. Usually, a welding operation is controlled according to a program designed to determine to move the tip of a welding wire along a weld line coinciding with the center line of the groove of a workpiece set by an operator. Therefore, if the operator finds the difference of the actual position of the groove from a design position through the observation of the workpiece or an image of the workpiece displayed on a welding monitor, the operator needs to give a welding path correction signal to the robot controller to correct the welding path.

In the automatic groove-tracing welding system in the first embodiment, the image processor 3 processes the image signal by the foregoing image processing operation to detect the edges B of the groove 51, decides a proper weld line L coinciding with a middle line bisecting a space between the two edges B, determines an error in the position of the tip P of the welding wire with respect to the weld line L, calculates a position correction on the basis of the error, sends a correction signal to the robot controller 43 of the welding robot 4, and then the robot controller 43 corrects the position of the tip P of the welding wire automatically without requiring the operator's manual operation.

The position of the tip P of the welding wire can be estimated from the position of the very bright region M of the image. However, since welding torch 1 and the camera head 2 are fixedly connected together, the position of the tip P of the welding wire in the image can be previously determined through measurement or calculation.

If the welding operation is performed with the workpiece 5 set oblique to an expecting welding direction, the tip P of the welding wire moves toward the wall of the groove unless the moving direction of the welding wire is corrected. Therefore, in such a case, a moving direction correcting operation is necessary. Since the edges B of the groove, in this case, extend obliquely as shown in FIG. 4, the edges B of the groove are detected, a correction signal for correcting the position of the tip P so that the tip P of the welding wire may move along a weld line L bisecting the space between the edges B is produced and is sent to the robot controller 43, and then the robot controller 43 corrects the moving direction of the tip P of the welding wire.

When the welding torch 1 is supported for turning around its axis to make the direction of the camera head 2 coincide with the moving direction of the welding torch 1, the welding torch 1 moves vertically in the image. Therefore, the direction of the edges B of the groove changes when the correction is made, and the weld line L appears in a vertical line in the image, which facilitates image processing. Whereas the control of the direction of the camera head 2 independently of the welding direction enhances difficulty in image processing, the same facilitates the operation of the welding robot 4.

If the welding torch 1 is moved for weaving in a state as shown in FIG. 4, the welding torch 1 is moved in directions α, namely, horizontal directions in the image. Consequently, the welding torch 1 is moved obliquely to the weld line L for weaving, which is undesirable. When an attempt is made to move the welding torch 1 for weaving in directions β, namely, directions perpendicular to the weld line L, an angle θ between the horizontal direction a and the direction β perpendicular to the weld line L is determined, and a correction signal for correcting the wearing width direction of the welding torch 1 for weaving is calculated from the angle θ, and given to the robot controller 43.

When the groove is not formed accurately and the actual width of the groove is different from the design width, the weaving width must be corrected to avoid defecting welding.

In such a case, a weld line is determined by calculation from the positions of the edges of the groove, the weaving movement of the welding torch 1 is controlled and a position correcting signal for correcting the position of the welding torch 1 is given to the robot controller 43 so that the center of weaving is on the centerline of the groove, and a correction signal for correcting the weaving width according to the width of the groove is given to the robot controller 43.

The weaving of the welding torch 1 is controlled so that the tip of the welding wire may not touch the groove faces. Therefore, a correction signal is produced to move the welding torch 1 for weaving such that the tip P of the welding wire is spaced a predetermined clearance apart from the edges B of the groove.

The weaving width needs to be increased and the distance between a weaving end point and the edge needs to be changed with the increase of weld layers when the automatic groove-tracing welding system operates for multilayer welding including weaving because the groove faces are inclined so as to diverge from each other.

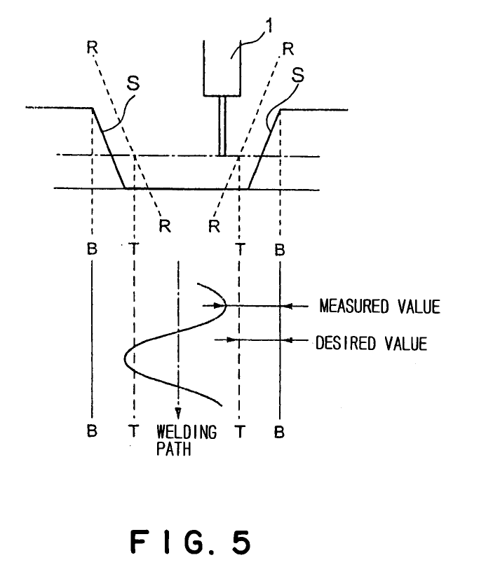

The automatic groove-tracing welding system performs a weaving width correcting operation taking the shape of the groove into consideration as shown in FIG. 5 to achieve satisfactory welding. In FIG. 5, the groove is shown in a sectional view in an upper part, and is shown in a plane view in a lower part.

Data on the groove angle of the groove 51 and the thickness of the workpiece 5 is given beforehand to the image processor 3. The image processor 3 calculates the positions S of the groove faces beforehand on the basis of the edges B detected from the image signal.

The image processor 3 sets limiting planes R spaced a predetermined clearance from the groove faces and defining weaving end points, and produces a correction signal for controlling the position of the welding torch 1 such that the tip P of the welding wire does not traverse the groove beyond the limiting planes R.

The height of the tip P of the welding wire is dependent on the position of the weld layer. The image processor 3 receives data on the height of the welding torch 1 from the robot controller 43, and calculates desired weaving end points T respectively for the heights of the welding torch 1. The desired weaving end points T are calculated with respect to the edges B, and the measured distance between an actual weaving end point corresponding to a traverse end position of the tip P of the welding wire with respect to the edge B is examined with comparing with the desired weaving end point T with respect to the edge B, and a correction is calculated.

The thickness of a weld layer differs from a design thickness if welding speed is not changed according to the change of the groove width and, consequently, a welded joint having a design strength cannot be formed. It is preferable to decrease welding speed to increase the amount of deposited molten metal when the groove width increases beyond a design groove width, and increase welding speed to decrease the amount of deposited molten metal when the groove width decreases.

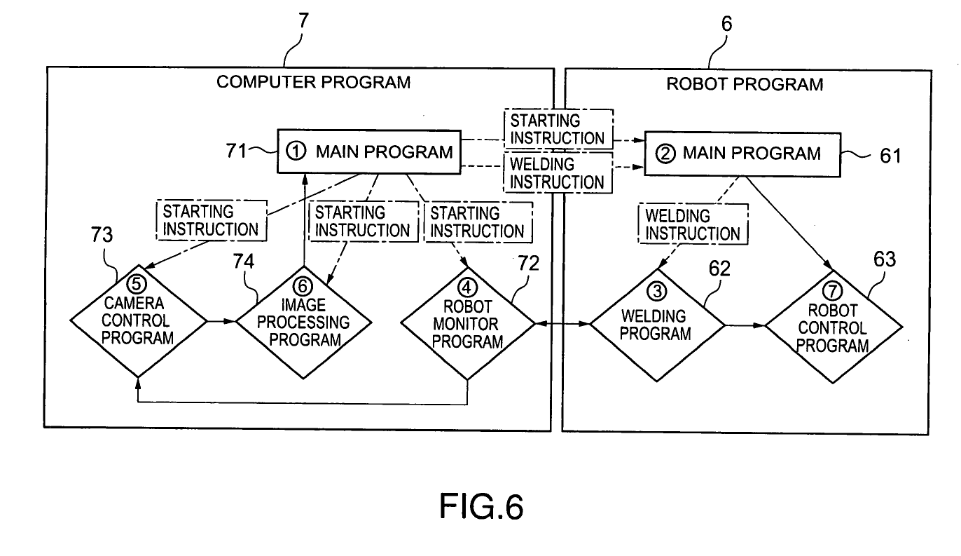

FIG. 6 is a flow chart of assistance in explaining the operation of the automatic groove-tracing welding system in the first embodiment.

The automatic groove-tracing welding system is featured by a computer program 7 that cooperates with a conventional robot program 6.

The robot program 6 is stored in the robot controller 43 and includes a main program 61, and two subprograms, namely, a welding program 62 and a robot control program 63.

The welding program 62 includes instructions for feeding the welding wire, operating the welding machine 41 and controlling the welding source 44. The robot control program 63 includes instructions for controlling the welding robot 4 to move the welding machine 41 to a desired position. The main program 61 includes instructions for matching the welding program 62 and the robot control program 63 to control the welding robot 4 properly for a desired welding operation.

The computer program 7 is stored in the image processor (personal computer) 3. The computer program 7 includes a main program 71, and three subprograms, namely, a robot monitor program 72, a camera control program 73 and an image processing program 74.

The robot monitor program 72 communicates with the welding program 62 for the welding robot 4 to monitor the condition of the welding machine 41. The camera control program 73 includes instructions for controlling the camera head 2. The image processing program 74 includes instructions for the foregoing image processing operations. The main program 71 communicates with the main program 61 of the robot program 6, gives instructions to the robot program 6, and includes instructions for matching the robot monitor program 72, the camera control program 73 and the image processing program to control the welding robot 4 properly for a desired welding operation.

The computer program 7 is operated to start the automatic groove-tracing welding system.

(1) The main program 71 of the computer program 7 generates a start instruction. Then, the robot program 6 and the subprograms 72, 73 and 74 of the computer program 7 execute a waiting loop and wait until conditions are formed.

(2) The robot program 6 starts the robot control program 63 to move the welding machine 41 to a predetermined position, and then gives a welding start instruction to the welding program 62.

(3) the welding program 62 is started and the welding source 44 provides the welding machine 41 with electric power so as to start a welding operation.

(4) The robot monitor program 72 monitors the welding program 62. Upon the detection of the start of the welding operation, the robot monitor program 72 instructs the camera control program 73 to start.

(5) The camera control program 73 instructs the camera head 2 to form an image of a weld zone.

(6) The image processing program 74 processes an image signal received from the camera head 2, displays an image based on the image signal on the display, and, when the position of the welding torch 1 needs to be corrected, calculates a correction and gives a correction signal representing the correction through the main program 71 to the main program 61 of the robot program 6.

(7) The robot control program 63 corrects the position and moving speeds and such of the robot arm 42 on the basis of instructions given thereto from the main program 61 to carry out welding conforming to the actual condition of a workpiece.

A weaving pattern for weaving is a periodic pattern. Therefore, it is reasonable to perform a measuring operation and a correction operation at a period corresponding to that of the weaving pattern. Preferably, the period is divided into divisional periods, a correction is divided into divisional corrections, and the divisional corrections are allocated to the divisional periods, respectively, to avoid changing the operation of the welding machine 41 stepwise at large steps. Therefore, the period is divided into divisional periods, the measuring operation is performed in each divisional period, and a correcting operation is performed in the succeeding divisional period. Thus, the correcting operation is also performed in some divisional periods. A correction is divided into divisional corrections for the divisional periods, and the condition of the welding machine 41 is corrected by the divisional correction in each divisional period to achieve a smooth correcting operation so that the condition may not be changed stepwise at large correction steps.

The measuring operation can be performed during the correcting operation to calculate a correction for the next cycle of the correcting operation.

In most cases, the tip P of the welding wire is moved for weaving in opposite directions at equal distances, respectively, from the weld line L. Therefore, when the measuring operation and the correcting operation are performed alternately in the weaving periods, measurement of the condition while the condition is being changed for correction can be prevented, and the condition can be effectively controlled in a feedback control mode.

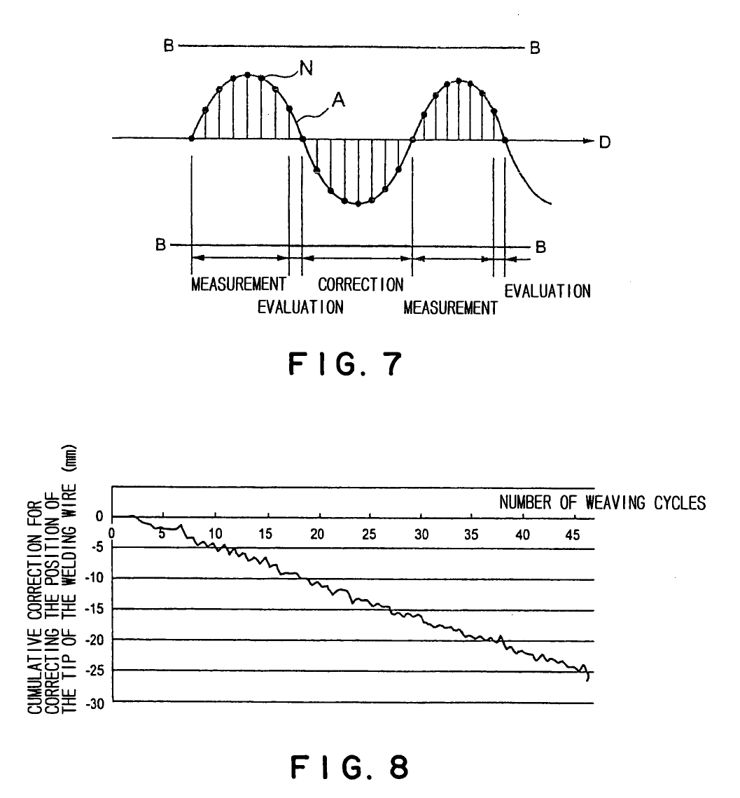

Each weaving period may be divided into a measuring period, an evaluating period and a correcting period as shown in FIG. 7, the measuring operation may be performed to obtain measurements in the first half period and the measurements are amplified to evaluate the condition in one period in the first half period, and the correcting operation may be performed in the second half period.

In FIG. 7, the arrow D indicates the moving direction of the center of the welding machine 41, a curve A represents the welding path of the tip of the welding torch 1. In FIG. 7, solid spots N are dividing points dividing one weaving period into sixteen equal divisional periods. In the state shown in FIG. 7, the welding torch 1 is moved to the left with respect to the moving direction D in the measuring period, features of an image are extracted to determine the positions of the edges B of the groove 51, and an error in the actual positions of the edges B with respect to the taught positions of the edges B is determined at times corresponding to the solid spots N on the left side.

The times corresponding to the solid spots N, and information about the positions of the welding torch 1 at those times are provided by the robot controller 43. When the weaving path is symmetrical with respect to the weld line L, the deviation of the moving direction of the welding torch 1 and the displacement of the weaving path can be known from the relation between the positions of the welding torch 1 measured at eight measuring points in the first half period and the positions of the edges B of the groove 51. A full correction is calculated at the end of the first half period, the full correction is divided into eight fractional corrections, and correction signals representing the eight fractional corrections are generated at times corresponding to the solid spots N in the second half period.

The motion of the welding torch 1 is corrected gradually according to the correction signals in the second half period.

When the first half period is divided into equal divisional periods, the full correction calculated on the basis of measurements obtained at times in the divisional periods are divided into n divisional corrections, and the n divisional corrections are allocated to times corresponding to n equal divisional periods in the second half period to perform the gradual correction in the second half period, the motion of the welding torch 1 can be smoothly corrected and high-quality welding can be achieved.

Since the weaving path has a predetermined shape, such as a sinusoidal shape, a necessary correction can be estimated by performing the measuring operation in a part of the weaving period. Therefore, the measuring operation and the correcting operation do not need to be performed in one or two weaving period; the measuring operation may be performed in the preceding m periods, and the correcting operation may be performed in the succeeding m periods.

FIGS. 8 to 11 are graphs showing the results of performance tests of the automatic groove-tracing welding system in the first embodiment.

In the performance tests, the welding torch 1 was held by the robot hand of a general-purpose robot, and a welding electric power of 260 A, a welding voltage of 30 V and a 1.2 mm diameter welding wire were used. ATARU was used as shielding gas. A filler metal was deposited in a groove having a groove angle of 45° formed in a steel workpiece by moving the welding torch at a welding speed of 15 cm/min and traversing the welding torch for weaving at a weaving frequency of 0.5 Hz. The welding robot generated signals at times corresponding to sixteen time points dividing one weaving period into sixteen divisional periods. Corrections were calculated sixteen times in the preceding weaving period and correcting operation was performed sixteen times in the succeeding weaving period.

The workpiece was placed with the edges of the groove extended at 6.6° to a weld line taught to the robot to evaluate the ability of the automatic groove-tracing welding system.

FIG. 8 is a graph showing the change of cumulative correction indicating the process of correcting the position of the tip of the welding wire, in which the number of weaving cycles is measured on the horizontal axis, and cumulative correction for correcting the position of the tip of the welding wire is measured on the vertical axis.

As obvious from FIG. 8, corrections were distributed in each weaving period, the correction signal changed gradually and, consequently, the robot arm moved very smoothly.

It is known from the graph shown in FIG. 8, that the mean correction in each weaving period was about 0.54 mm. Since the distance traveled by the welding torch in each weaving period is: 15 cm/min×(1/0.5 Hz)=150 mm/60 s×2 s=5 mm, and the edges of the groove of the workpiece extends at 6.60 to the weld line taught to the robot, the correction is 5 mm×tan 6.60=0.58 mm.

Thus, it is known that the correction for correcting the position of the welding wire determined by processing an image during welding by the automatic groove-tracing welding system is substantially equal to a theoretical value.

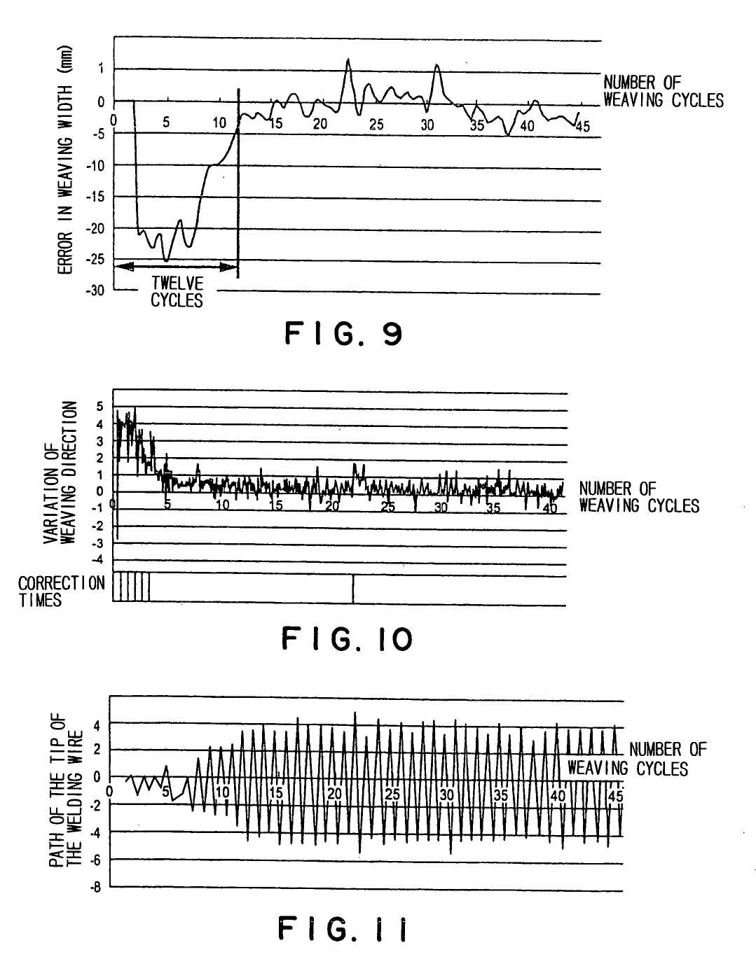

FIG. 9 is a graph showing the result of weaving width error correction, in which error in weaving width, i.e., the deviation of actual weaving width from correct weaving width, is measured on the vertical axis, and the number of weaving cycles is measured on the horizontal axis.

The graph shows the process of automatic correction of errors when an initial set value is 1 mm for a workpiece requiring weaving in a weaving width of 8 mm. Weaving width error in the graph shown in FIG. 9 were determined by the image processor. The weaving width correction necessary at each time is fixed to simplify the automatic groove-tracing welding system.

It is known from FIG. 9 that a correct weaving end point was attained in twelve weaving cycles after the welding torch had been advanced by 3 cm from a starting position. The number of weaving cycles that required a correction of 1 mm was 1.7.

Such a large error does not appear stepwise in actual welding and hence it is known from the foregoing results of tests that the automatic groove-tracing welding system of the present invention has a sufficient, practically effective ability.

FIG. 10 is a graph showing the result of weaving width direction control based on the result of image processing, and an upper part of FIG. 10 the number of weaving cycles is measured on the horizontal axis, and the variation of weaving width direction, i.e. the angle of weaving direction to the weld line, is measured on the longitudinal axis. Correction times when the correction of weaving direction was made on the basis of calculated data are shown in a bottom part of FIG. 10.

The automatic groove-tracing welding system in the first embodiment performs the weaving width direction correcting operation only once in each weaving period. The weaving width direction is corrected by a prescribed angle, i.e., +1° or −1°, when the angular deviation of the weld line determined through image processing from the prescribed weld line is not included in the range of ±1° throughout number of weaving cycles.

In the tests, weaving width direction correction was performed six times. Since the error in the initial weld line was 6.6°, correction of 1° was performed six times and the final deviation of the corrected weld line from the actual line was only 0.6°.

Initial five correcting operations were completed in the initial five weaving cycles, which proved that the response characteristic of the automatic groove-tracing welding system was satisfactory.

FIG. 11 shows the welding path of the tip of the welding wire when a wire position correcting operation, a weaving width correcting operation and a weaving width direction correcting operation were performed simultaneously, in which the number of weaving cycles is measured on the horizontal axis, and the displacement of the tip of the welding wire is measured on the vertical axis.

It is known from FIG. 11 that a set initial weaving width of 1 mm is corrected automatically and the weaving operation of the tip of the welding wire is stabilized after the twelfth weaving cycle.

The test result shows that the automatic groove-tracing welding system in the first embodiment is capable of satisfactorily and automatically carrying out welding involving weaving without requiring operator's manual assistance.

Although the image processor of the automatic groove-tracing welding system may be special hardware, it is advantageous to use a programmable electronic computer, such as a simple personal computer, as the image processor because the programmable electronic computer permits optional adjustment of parameters for control operations and optional designing of display format.

A single electronic computer may be used for managing and controlling a plurality of welding machines.

The automatic control of a welding machine can be achieved by incorporating the function of the image processor of the present invention into a conventional monitor. Thus use of existing equipment is effective in remarkably reducing the cost of equipment.

Second Embodiment

An automatic groove-tracing welding system in a second embodiment according to the present invention is intended for application to arc welding using a nonconsumable electrode and a welding wire, such as TIG welding. The automatic groove-tracing welding system in the second embodiment is similar in construction, operation and effect to the automatic groove-tracing welding system in the first embodiment. The automatic groove-tracing welding system in the second embodiment has an additional function to correct the unsymmetry of the molten pool that occurs when weaving is not performed.

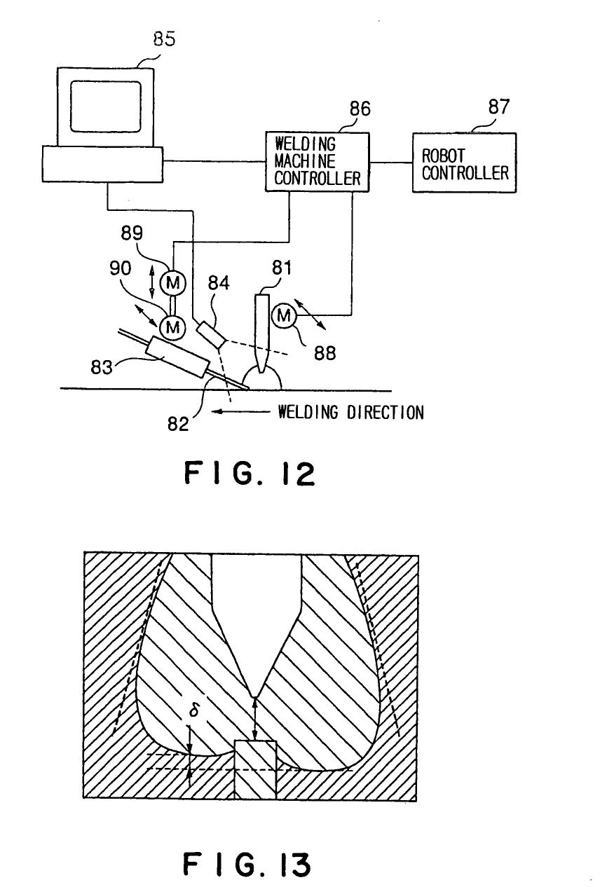

FIG. 12 is a block diagram of the automatic groove-tracing welding system in the second embodiment.

The automatic groove-tracing welding system in the second embodiment includes a welding torch 81, a welding wire feeder 83 that feeds a welding wire 82, a camera head 84 interlocked with the welding torch 81, an image processor 85, such as a personal computer, a welding machine controller 86, a welding robot, not shown, and a robot controller 87.

The welding robot holds a welding machine including the welding torch 81 and the welding wire feeder 83 by a robot hand attached to the extremity of an articulated robot arm, and controls the position of the welding machine during welding. The welding machine controller 86 is internally provided with a welding source to supply a welding electric power to the welding torch 81. The welding machine controller positions and feeds the welding wire.

When an automatic welding machine is used instead of the general-purpose robot, a controller capable of controlling the position and attitude of the automatic welding machine is employed instead of the robot controller.

The welding torch 81 is controlled by the robot controller 87 according to a preset control program so as to trace a groove formed in workpiece, and deposits a filler metal in the groove by melting the welding wire to weld the workpiece.

The welding torch 81 is provided with a drive motor 88. The drive motor is controlled by the welding machine controller to adjust the traverse position of the welding torch 81. The welding torch 81 is provided with a drive motor, not shown, for moving the welding torch 81 vertically toward and away from the workpiece. This drive motor is controlled by the robot controller in the conventional manner.

The welding wire feeder 83 is provided with a vertical drive motor 89 and a horizontal drive motor 90. The vertical drive motor 89 and the horizontal drive motor 90 drive the welding wire feeder 83 respectively for vertical movement and horizontal movement.

The camera head 84 is attached to the welding torch 81 such that a molten pool is within the visual field of the camera head 84.

As shown typically in FIG. 13, an image formed by the camera head 84 during welding has a very bright region corresponding to a region around the tip of the welding torch 81, a bright region around the very bright region, corresponding to a molten pool, and a dark region around the bright region. Although the image of the welding wire is shown in a brightness similar to that of the image of the molten pool, the position of the tip of the welding wire can be determined by image processing.

The image processor 85 determines the position of the tip of the welding torch 81 in the very bright region, and determines the respective positions of a groove and the tip of the welding wire in the bright region around the very bright region.

The automatic groove-tracing welding system in the second embodiment guides the welding torch 81 by a method similar to that by which the automatic groove-tracing welding system in the first embodiment guides the welding torch, drives the vertical drive motor 89 and the horizontal drive motor 90 according to the positional relation between the welding torch 81 and the welding wire 82 in the image to make the welding wire 82 follow the welding torch 81 for straight welding or welding involving weaving.

The welding torch 81 is guided for straight welding so as to move along a proper line between the opposite edges of the groove, such as a middle line bisecting a space between the opposite edges of the groove. In some cases, the respective conditions of a right part and a left part of the molten pool on the right and the left side of the welding wire 82 differ from each other when the welding wire 82 is disposed at a fixed position ahead of the welding torch 81 for welding, i.e., an asymmetrical molten pool is formed. Since such an asymmetrical molten pool deteriorates weld quality, the welding wire 82 needs to be shifted toward the side of a part in which the melting of the metal is delayed to form a symmetrical molten pool.

In the automatic groove-tracing welding system in the second embodiment, the welding torch 81 and the welding wire 82 can be individually controlled, and the condition of the molten pool can be examined through the observation of the image formed by the camera head 84, and hence the condition of the molten pool can be automatically corrected.

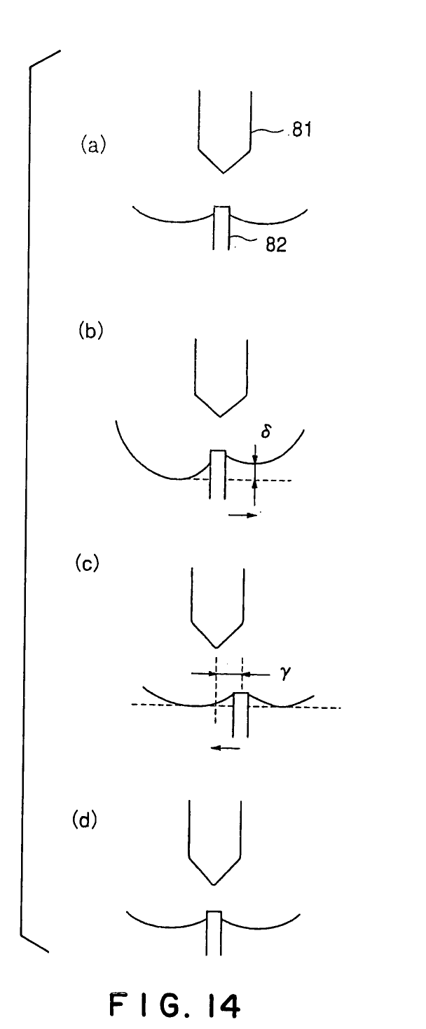

FIG. 14 is a view of assistance in explaining steps of a molten pool shaping procedure for adjusting the shape of the molten pool.

FIG. 14(a) shows a normal welding state. If an asymmetric molten pool is formed due to some cause such that the respective conditions of a right part and a left part of the molten pool on the right and the left side of the welding wire 82 differ from each other as shown in FIG. 14(b), and there is a difference δ in position with respect to the welding direction between the respective front ends of the right and the left part of the molten pool, the image processor 85 detects the difference δ, operates the horizontal drive motor 90 to shift the welding wire 82 by a distance γ toward the side of the part in which the development of the molten pool is delayed.

Consequently, the front end of the part in which the development of the molten pool is delayed advances relative to the front end of the other part of the molten pool as shown in FIG. 14(c). After the confirmation of the substantial coincidence of the respective positions of the respective front ends of the right and the left part of the molten pool, the welding wire 82 is returned to its normal position for a normal welding operation as shown in FIG. 14(d).

The horizontal displacement y may be proportional to the difference δ. The position of the welding wire 82 may be controlled by an advanced control method. The control operation may be started when the difference 6 increases beyond an allowable limit taking hysteresis into consideration.

The position of the welding wire 82 does not need to be controlled during weaving. A welding wire control operation for controlling the position of the welding wire and a weaving control operation for controlling weaving may be interlocked to inhibit the welding wire control operation while the weaving control operation is being performed.

As apparent from the foregoing description, the automatic groove-tracing welding system of the present invention corrects the position of the tip of the welding wire, weaving width, weaving width direction, the amount of deposited metal and the irregular molten condition with respect to a welding direction can be automatically corrected. Consequently, unmonitored, automatic welding can be achieved. Since any operator's decision is not necessary, chances of wrong decisions and faulty operations having serious influence on weld quality can be reduced.

1. An automatic groove-tracing welding system comprising: a welding torch guide device; an imaging device; and an image processor; wherein the imaging device produces an image signal representing an image of a weld zone including the tip of a welding wire, the image processor receives the image signal from the imaging device, and a torch tip position information about the position of the tip of the welding torch from the welding torch guide device, determines the position of a groove from the image of the weld zone, calculates the positional relation between the groove and the welding torch on the basis of the torch tip position information, and sends a position correction signal for correcting the position of the tip of the welding torch so that the welding path of the tip of the welding torch may coincide with a weld line coinciding with a predetermined middle part of the groove to the welding torch guide device.

2. The automatic groove-tracing welding system according to claim 1, wherein the torch guide device holds and guides a consumable electrode.

3. The automatic groove-tracing welding system according to claim 1 further comprising a welding wire feed device for feeding a welding wire and adjusting the position of the tip of the welding wire, wherein the torch guide device holds and guides a nonconsumable electrode.

4. The automatic groove-tracing welding system according to claim 1, wherein the welding torch guide device is capable of weaving operation, the image processor receives a weaving phase signal representing a weaving phase from the welding torch guide device, calculates the positional relation between the groove and the welding torch on the basis of the weaving phase, and sends a weaving width correction signal for correcting the weaving width to the welding torch guide device.

5. The automatic groove-tracing welding system according to claim 4, wherein the image processor determines the positional relation between the groove and the welding torch and sends a weaving width correction signal to the welding torch guide device in the first half of a weaving period, and the welding torch guide device corrects the position of the welding torch in the second half of the weaving period.

6. The automatic groove-tracing welding system according to claim 4, wherein the image processor generates n dividual position corrections (n is a positive integer) for correcting the position of the welding torch by equally dividing a position correction in m periods (m is a positive real) of weaving and sends correction signals representing the dividual position corrections to the welding torch guide device, and the welding torch guide device corrects the position of the welding torch at n dividual phases determined by dividing m periods of weaving.

7. The automatic groove-tracing welding system according to claim 4, wherein the image processor calculates the position and sectional shape of the groove, defines a weaving range, and sends a weaving correction signal for correcting the weaving operation so that the welding torch operates for weaving in the defined weaving range to the welding torch guide device.

8. The automatic groove-tracing welding system according to claim 4, wherein the image processor calculates a direction in which the groove extends, and sends a weaving width direction correction signal for correcting the traversing direction of weaving to the welding torch guide device.

9. The automatic groove-tracing welding system according to claim 1, wherein a welding speed correction signal for correcting welding speed according to the width of the groove determined by the image processor is sent to the welding torch guide device.

10. The automatic groove-tracing welding system according to claim 1, wherein the imaging device is fixed relative to the welding torch.

11. The automatic groove-tracing welding system according to claim 3, wherein the image processor determines the respective positions of the respective front ends, with respect to a welding direction, of right and left parts of a molten pool on the right and the left side of the tip of the welding wire from an image of the weld zone, calculates a difference in position with respect to the welding direction between the respective front ends of the right and the left part of the molten pool, sends a correction signal for correcting the positional difference between the respective front ends of the right and the left part of the molten pool to the welding wire feed device, and the welding wire feed device shifts the tip of the welding wire toward one part of the molten pool on one side of the tip of the welding wire having a front end lying behind the front end of the other part of the molten pool to form a symmetrical molten pool.

12. An automatic groove-tracing welding method using a remote-controlled welding torch guide device, said automatic groove-tracing welding method comprising: generating an image signal by taking an image of a weld zone including the tip of a welding wire; determining the position of a groove from the image signal representing the image of the weld zone; obtaining welding torch tip position information about the position of the tip of a welding torch from the welding torch guide device; calculating the positional relation between the groove and the tip of the welding wire on the basis of the welding torch tip position information; and achieving welding position control by sending a position correction signal to the welding torch guide device to adjust the welding path of the tip of the welding torch so that the welding path of the tip of the welding torch may coincide with a predetermined middle position in the groove.

13. The automatic groove-tracing welding system according to claim 2, wherein the welding torch guide device is capable of weaving operation, the image processor receives a weaving phase signal representing a weaving phase from the welding torch guide device, calculates the positional relation between the groove and the welding torch on the basis of the weaving phase, and sends a weaving width correction signal for correcting the weaving width to the welding torch guide device.

14. The automatic groove-tracing welding system according to claim 3, wherein the welding torch guide device is capable of weaving operation, the image processor receives a weaving phase signal representing a weaving phase from the welding torch guide device, calculates the positional relation between the groove and the welding torch on the basis of the weaving phase, and sends a weaving width correction signal for correcting the weaving width to the welding torch guide device.
